(19) United States
(12) Patent Application Publication
(10) Pub. No.: US 2026/0351650 A1
(43) Pub. Date: Nov. 5, 2026

(54) PROTECTIVE ELEMENT FOR ARRANGEMENT ON OR IN A DEVICE, AND DEVICE HAVING A PROTECTIVE ELEMENT

(71) Applicant: ElringKlinger AG, Dettingen (DE)

(72) Inventors: Bernd TRABER, Dettingen (DE); Sergio MORENO-LECHADO, Dettingen (DE)

(73) Assignee: ElringKlinger AG, Dettingen (DE)

(21) Appl. No.: 19/711,381

(22) Filed: Jun. 17, 2026

Related U.S. Application Data
(63) Continuation of application No. PCT/EP2025/050826, filed on Jan. 14, 2025.

(30) Foreign Application Priority Data
Jan. 19, 2024 (DE) 10 2024 101 646.9

(51) Int. Cl. H01M 10/02

(52) U.S. Cl. CPC H01M 10/02; H01M 2200/10

(57) ABSTRACT

A protective element for arrangement on or in a device, in particular on or in an electrical energy storage device, wherein the protective element comprises a carrier structure and at least one insulating layer. The protective element moreover comprises at least one connecting layer for connecting the carrier structure to the at least one insulating layer.

### RELATED APPLICATION

This application is a continuation of international application No. PCT/EP2025/050826 filed on 14 Jan. 2025 and claims the benefit of German application No. 10 2024 101 646.9 filed on 19 Jan. 2024, which are incorporated herein by reference in their entirety and for all purposes.

### FIELD OF DISCLOSURE

The present invention relates to a protective element for arrangement on or in a device and to a device having such a protective element.

### BACKGROUND

Many devices, in particular electrical energy storage devices, are subject to numerous challenges and/or stresses.

For example, climatic and/or mechanical influences which stress the devices often occur during operation and/or during storage.

Such stresses can not only cause a reduction in efficiency but also damage to or even failure of the device.

Thus, for example, so-called thermal runaway (i.e. an exothermic chain reaction) in the case of an energy storage device entails a high potential for risk.

Housings made from special polymers and single-or multi-layer metal housings (for example, made from cast aluminum) are known from the prior art. Also known from the prior art are housings with an additional, internal protective layer (for example made from mica moldings).

Also known are functional coatings, for example in the form of intumescent varnish for enhanced flame retardancy, anti-corrosion varnishes, or varnishes for increasing the dielectric strength.

Because of the wide range of requirements, there is a very large number of known approaches. However, they often do not provide comprehensive protection. Combinations of materials which, for example, provide sufficient resistance to thermal runaway of battery cells can, because of their weight, prove to be disadvantageous.

Combinations of materials which provide sufficient protection from electrical breakdown may, for example, be unsuitable in terms of thermal requirements.

The alternative combinations of materials and approaches to solving the problem are even more numerous than the requirements placed upon them. There is therefore currently no known system which meets all the technical and commercial requirements.

### SUMMARY OF THE INVENTION

The object of the present invention is therefore to specify a protective element and a device which are adapted to different protection requirements and at least reduce the above disadvantages.

With regard to the protective element, the object is achieved according to the invention by a protective element having the features of the independent claim(s). With regard to the device, the object is achieved according to the invention by a device having the features of the claimed invention.

Advantageous embodiments, developments, and variants are specified in the dependent claims.

The advantages explained with respect to the protective element and preferred embodiments are transferable analogously to the device, and vice versa.

Specifically, the object relating to the protective element is achieved by a protective element for arrangement on or in a device.

In particular, the device can be an electrical energy storage device, for example a box with one or more batteries or battery cells.

The protective element can in an alternative embodiment also be a part of the device, for example a part of the electrical energy storage device. In particular, the protective element can here preferably be a part of a housing or be arranged between individual cells, for example battery cells, of the electrical energy storage device. The protective element then here preferably forms a so-called intercellular protective element.

The protective element advantageously has a carrier structure and at least one insulating layer and at least one connecting layer.

It can be favorable if the carrier structure thermally and/or mechanically and/or chemically protects and/or shields one or more insulating layers, in particular separates the latter spatially from the exertion of heat. Alternatively or additionally, it can here be provided that the carrier structure is thermally and/or mechanically and/or chemically protected and/or shielded by means of one or more insulating layers.

Mechanical protection is preferably effected in particular by a material being used which is mechanically robust and abrasion-resistant when impacted by particle-laden hot gas, in particular from an off-gassing battery cell.

The carrier structure preferably forms a type or core of the protective element.

The carrier structure is preferably formed from a solid material, i.e. it has for example no air pockets and/or material inclusions of a different material.

Alternatively, the carrier structure can preferably be formed as a frame. The carrier structure can moreover preferably have gaps. A material other than the material of the frame can, for example, be introduced into the gaps. For example, the gaps can include air in order to form a light carrier structure.

The at least one insulating layer preferably serves to insulate and thus protect the device from different influences.

The connecting layer preferably serves to connect the carrier structure to the at least one insulating layer.

The layers can be connected to one another, for example by adhesive bonding, over their whole surface or also only partially, in particular locally intermittently and/or in a regular pattern.

It can, for example, be provided that the carrier structure be connected, for example by adhesive bonding, to one or more insulating layers over its whole surface or also only partially, in particular locally intermittently and/or in a regular pattern.

The connecting layer can, for example, be part of the carrier structure and/or part of the insulating layer or a separate layer from the latter.

Furthermore, alternatively or additionally, the connecting layer can be an adhesion and/or cohesion layer such that the carrier structure and the at least one insulating layer are preferably connected to at each other by attraction forces between particles of the same type within a material and/or by attraction forces at an interface of two different materials, for example the material of the carrier structure and the material of the insulating layer. According to this embodiment, there is thus preferably no separate connecting layer arranged between the carrier structure and the respective insulating layer. Instead, the connecting layer is then the transition region or boundary region between the parts or layers adjoining one another.

Different protection or insulation requirements can advantageously be taken into account by the choice of at least one suitable insulating layer.

In this way, climatic and/or mechanical and/or physical and/or chemical and/or mechanical influencing factors can, for example, be addressed by it being possible for the protective element preferably to be adapted to the respective stresses by different insulating layers.

(Functional) impairment of the device can advantageously at least be reduced or avoided altogether.

In one embodiment, the carrier structure comprises one or more carrier layers or is formed therefrom.

In particular, the carrier structure can comprise one or more metal layers.

The plurality of carrier layers, in particular the plurality of metal layers, preferably offer protection from mechanical stresses and/or the penetration of foreign bodies (into the protective element and/or the device) and/or thermal stresses and/or electromagnetic stresses.

For example, in the case of thermal runaway of a cell, electrical charging of constituent parts of the device and/or of the protective element can occur. At least one part of the protective element is therefore preferably designed as electrically conductive.

It can be favorable if the carrier structure and/or a layer, for example an insulating layer, which is arranged on a side, facing away from the cell, of the carrier structure, takes the form of an electrically conductive layer, or comprises the latter. In particular, a build-up of potential can consequently be avoided by bypassing and/or grounding.

It can, for example, be provided that the conductivity of the carrier structure and/or of the layer is effected by the use of electrically conductive particles.

In an alternative embodiment, the carrier structure can comprise one or more wooden layers.

It can be advantageous if the plurality of carrier layers are connected to one another to form the carrier structure, for example are adhesively bonded to one another and/or are connected to one another by the above described adhesion and/or cohesion forces.

The carrier structure preferably extends over the whole or part of the length and/or the surface of the protective element.

According to a preferred embodiment, the carrier structure can be electrically insulated at its end sides.

It may be advantageous if the protective element comprises a plurality of insulating layers. In particular, the plurality of insulating layers can be arranged on both sides of the carrier structure.

As a result, the protective or insulating effect of the protective element can be increased. Such a configuration can, within the meaning of this application and because of the multi-layer construction, also be referred to as a multi-layer composite.

Particularly preferably, the plurality of insulating layers differ in terms of their insulating properties. In particular, the plurality of insulating layers differ in terms of their thermal and/or electrical and/or electromagnetic and/or mechanical insulating properties.

The different insulating properties are, however, not restricted to the abovementioned insulating properties. Instead, other insulating properties are also conceivable such as, for example, physical and/or chemical insulating properties and/or any application-specific insulating properties.

For example, at least one of the plurality of insulating layers has a preferably thermal insulating effect, whilst at least one other of the plurality of insulating layers has a preferably electrical insulating effect.

By virtue of such a configuration, the protective element can preferably be adapted to, for example, predetermined (insulation) requirements.

In one embodiment, precisely one connecting layer is preferably arranged between each of a plurality of the insulating layers. The protective element can thus as a whole have a plurality of connecting layers, which preferably increases mechanical cohesion of the protective element.

It can moreover be advantageous if at least one insulating layer has a thickness in the range from 0.01 mm to 1 mm, in particular in the range from 0.05 mm and 0.8 mm, specifically in the range from 0.2 mm to 0.6 mm.

If the protective element has a plurality of insulating layers, the plurality of insulating layers can either have the same thickness or alternatively have different thicknesses.

It can furthermore be advantageous if at least one insulating layer has different thicknesses in some regions and/or a structured surface.

According to one alternative embodiment, preferably all the insulating layers have different thicknesses in some regions and/or a structured surface.

The term structured surface can, within the meaning of this application, be understood to mean, for example, a pimpled and/or grooved surface. Such structured surfaces can, for example, cause an enlargement of the surface and thus advantageously create an effective insulating surface.

At least one insulating layer can preferably comprise a coating or an individual insulating layer.

In particular, at least one insulating layer can preferably be a coating or an individual insulating layer.

Furthermore, alternatively at least one insulating layer can preferably comprise a plurality of single insulating layers or be formed from a plurality of single insulating layers. The plurality of individual insulating layers can, for example, be adhesively bonded to form the insulating layer.

In one embodiment, the protective layer is arranged at least in some regions on or in the device.

The protective element is particularly preferably arranged at least in some regions on an outer side or an inner side of a wall of the device.

According to an alternative embodiment, the protective element can preferably also be arranged between two components of the device, in particular of the electrical energy storage device. The protective element can, for example, be arranged between two battery cells in the interior of a battery (box).

This is advantageous because the protective element can be arranged precisely at the location on the device at which it is intended or required to protect the device.

According to a further embodiment, at least one insulating layer surrounds the carrier structure in some regions.

In an alternative embodiment, at least one insulating layer preferably completely surrounds the carrier structure.

In particular by virtue of the carrier structure being completely surrounded by at least one insulating layer, the carrier structure can advantageously also be protected by the at least one insulating layer.

It can moreover be advantageous if the carrier structure includes a metal or is formed from a metal.

The carrier structure can, for example, include stainless steel and/or aluminum and/or a metal alloy.

The advantage here is that the carrier structure maintains sufficient mechanical stability and thus can preferably protect the protective element and hence the device from mechanical stresses.

The thermal conductivity of metal moreover advantageously contributes to the ability to distribute localized heating of the carrier structure.

In an alternative configuration, the carrier structure can include wood and/or plastic or be formed from wood and/or plastic.

The wooden design of the carrier structure enables a lighter carrier structure than the metal carrier structure.

The material of the carrier structure is, however, not restricted to the abovementioned materials metal, wood and/or plastic. Instead, any suitable material can be employed for the carrier structure.

Within the meaning of this application, the term suitable material can be understood to mean a material which generally meets the requirements for the carrier structure and, for example, mechanically stabilizes the protective element and/or gives the protective element a thermal and/or electromagnetic insulating effect.

It can be advantageous if at least one insulating layer includes a thermally insulating material or is formed therefrom.

For example, at least one insulating layer includes silica fibers and/or thermal insulating paper and/or glass fabric and/or ceramic fiber mats and/or a temperature-resistant plastic foam and/or a temperature-resistant varnish or is formed from such materials.

Moreover, in one embodiment the insulating layer can include insulating paper or be formed from insulating paper.

Furthermore, at least one insulating layer can preferably include an intumescent material.

The term intumescent material can, according to the present application, be understood to mean a material which, when acted upon by heat, increases in volume and correspondingly decreases in density. For example, the intumescent material can form a foamed ash layer which prevents the supply of oxygen and thus propagation of flames.

It can be particularly preferred if, for example, the outermost insulating layer of the protective element includes an intumescent material or is formed from an intumescent material. By virtue of this embodiment, for example in the event of a fire the insulating layer including the intumescent material is first to come into contact with the heat and can thus optimally display its protective or insulating effect.

Non-limiting examples of intumescent materials are:
water-based intumescent material,
solvent-based intumescent material, or
epoxy-based intumescent material.

In particular, the thermal properties of intumescent materials are determined specifically by their chemical composition. Particularly suitable intumescent materials include, for example, a water-soluble alkaline silicate binder. Such materials preferably include a silica content of no more than 96% and/or an N-octyl- 2-pyrrolidone content within the range between 0.1% and 1%.

It can additionally be advantageous if the intumescent material includes an additive.

The additive can, for example, include a thermally insulating material, in particular an aerogel, or be formed therefrom. Such thermally insulating materials have a low thermal conductivity and are often also certified to that effect. Such a certificate or test is, for example, the UL94 flammability test. By virtue of the additive taking the form of a thermally insulating material, the thermal protection of the insulating layer can therefore be increased. In addition to the thermal protective effect of an aerogel, the latter also provides protection from electrical breakdown such that in addition the electrical resistance is also improved when an aerogel is used.

Suitable aerogels are, for example, aerogels which take the form of hydrophilic and synthetic, highly amorphous, silicate solids. Such aerogels have, for example, particle sizes in the range from 1 to 70 μm, preferably in the range from 1 to 20 μm, and specifically in the range from 10 to 15 μm. These aerogels moreover have pore sizes in the range from 1 to 50 nm, preferably in the range from 10 to 30 nm, and specifically in the range from 15 to 25 nm. The thermal conductivity of such aerogels has a value in the range between 0.025 and 0.03 W/(mK).

In order to further increase the mechanical resistance of the insulating layer, it can be favorable if the additive includes fibers, in particular glass fibers and/or metal fibers and/or metal alloy fibers and/or ceramic fibers, or is formed therefrom.

Alternatively or additionally, a nonwoven or woven fabric consisting of the abovementioned materials instead of or in addition to the fibers can also be provided.

The abovementioned additives are, however, not limited to the use with or in an intumescent material. Instead, the additives can also be contained in one or more of the materials listed in this application for the insulating layers and/or the connecting layers.

It can be particularly advantageous if at least one insulating layer and/or at least one carrier structure, in particular at least one carrier layer, contains at least one alloy which is stable at high temperatures, according to the formula (I)

MCrAlXZ (I)

or is formed therefrom, where

M stands for at least one of the chemical elements Ni, Co, Fe,

X stands for at least one optional chemical element which is chosen from Y, Si and/or Ti,

Z stands for at least one optional further chemical element.

### The Chemical Elements for Which X and Z Can Stand Are Optional.

If only the chemical element X or only chemical elements X is or are present, but chemical elements Z are not, the formula (I) can be MCrAlX.

If only the chemical element Z or only chemical elements Z is or are present, but chemical elements X are not, the formula (I) can thus be MCrAlZ.

If there are no chemical elements X and Z, the formula (I) can be MCrAl.

M can preferably stand for at least one of the chemical elements Ni or Co.

It can be particularly preferred if M stands for the chemical element Ni.

X can preferably stand for the chemical element Y.

Z can preferably comprise at least one of the chemical elements Ta, Mo, W, C, B, Zr, Nb, Hf.

The weight percentage of the chemical element Cr can advantageously be 2 to 55 wt. %, preferably 4 to 45 wt. %, particularly preferably 6 to 40 wt. %, for example 10 to 30 wt. %.

The weight percentage of the chemical element Al can advantageously be 1 to 35 wt. %, preferably 1.5 to 28 wt. %, particularly preferably 1.5 to 18 wt. %, for example 2 to 10 wt. %.

The weight percentage of the optional chemical element which X stands for, or the optional chemical elements which X stands for, can advantageously be up to 5 wt. %, preferably 0.01 to 4 wt. %, particularly preferably 0.02 to 3 wt. %, for example 0.03 to 3 wt. %. If X stands for more than one of the chemical elements Y, Si, Ti, the multiple chemical elements which X stands for are included in the calculation of the weight percentage.

The weight percentage of the chemical element which Z stands for, or the chemical elements which Z stands for, can advantageously be up to 18 wt. %, preferably 0.001 to 18 wt. %, particularly preferably 0.02 to 15 wt. %. If Z stands for more than one chemical element, the multiple chemical elements which Z stands for are included in the calculation of the weight percentage.

The weight percentage of the chemical element which M stands for, or the chemical elements which M stands for, can advantageously be 8 to 97 wt. %, preferably 20 to 95 wt. %, particularly preferably 45 to 93 wt. %. If M stands for more than one chemical element, the multiple chemical elements which M stands for are included in the calculation of the weight percentage.

According to one embodiment, a plurality of the insulating layers can also include a thermally insulating material, for example of the abovementioned type, or be formed therefrom.

Such insulating layers preferably increase the thermal insulating effect of the protective element and offer, for example, protection in the case of thermal runaway, for example of battery cells of the device which takes the form of an energy storage device.

The thermally insulating material is, however, not limited to the materials listed above. Instead, other materials can also be used which preferably have thermal insulating properties.

It can moreover be advantageous in terms of electrical insulation if at least one insulating layer includes an electrically insulating material or is formed therefrom.

For example, at least one insulating layer includes a plastic and/or a ceramic and/or a plastic film or is formed from such a material.

In terms of the electrically insulating aspect, when an intumescent material is used in one or more insulating layers, the intumescent material can also include an additive which preferably comprises ceramic particles or is formed therefrom.

According to one embodiment, a plurality of the insulating layers can also include an electrically insulating material, for example of the abovementioned type, or be formed therefrom.

The electrically insulating material is, however, not restricted to the materials listed above. Instead, other materials can also be used which preferably have electrical insulating properties.

A ceramic-based coating and/or a water-based coating and/or a glass-based coating and/or an epoxy-based coating and/or a powder coating are particularly preferred.

Ceramic-based coatings can advantageously form or have a thermal and/or electrical insulating effect and/or mechanically robust reinforcement.

For example, a ceramic-based coating can offer protection from particle impact in the case of thermal runaway. Ceramic coatings preferably withstand temperatures of 1000 °C and above.

The water-based coating can be, for example, a polymer coating.

Glass-based coatings can, for example, increase the physical and/or chemical resistance of the protective element and thus of the device.

The epoxy-based coating can be, for example, a 2-component epoxy coating. Such coatings preferably offer protection from moisture and/or chemicals and/or dirt and/or dust.

Alternatively or additionally, the coating can preferably also include a varnish or be formed from a varnish. The varnish can, for example, be a fire-retardant varnish and/or an anti-corrosion varnish and/or an electrical insulation varnish.

The varnish can advantageously be applied by a brush and/or by rolling and/or spraying and/or fine-spraying and/or dip-coating.

It can moreover be advantageous if the coating includes an intumescent material, in particular of the type already mentioned above, or is formed therefrom. Such coatings consisting of intumescent materials have proved to be advantageous because they make possible a thin and light but at the same time very resistant insulation.

Furthermore, according to one embodiment, at least one insulating layer can include a mechanically robust material or be formed therefrom. For example, at least one insulating layer can comprise a fiber-reinforced composite material or be formed therefrom.

In one embodiment, at least one connecting layer includes a binder or is formed therefrom.

In particular, the binder can advantageously be a ceramic-based binder and/or a water-based binder and/or a glass-based binder and/or an epoxy-based binder.

By virtue of the different options for the configuration of the binder of at least one connecting layer, the latter can, in addition to the function of connecting the carrier structure and at least one insulating layer to each other, preferably also have an insulating effect thermally and/or electrically and/or electromagnetically and/or with respect to moisture and thus advantageously increase the overall protective effect of the protective element.

According to one embodiment, at least one connecting layer can include an adhesive or be formed therefrom.

In particular, the adhesive can be an acrylate-based adhesive.

The adhesive can particularly preferably be an adhesive strip, in particular a double-sided adhesive strip.

It can moreover be advantageous if the adhesive includes reinforcement structures. Such reinforcement structures can be, for example, woven fabric structures and/or frame-like reinforcements, for example made from plastic.

Specifically, the object relating to the device is achieved by a device, in particular an electrical energy storage device, which comprises a protective element of the abovedescribed type.

According to one embodiment, the device can preferably be one or more of the devices listed below by way of example:
a housing; and/or
a module cover; and/or
a battery cover; and/or
an electrical energy storage device; and/or
a battery cell.

Moreover, in one embodiment the protective element can also be arranged between two cells of the device, in particular between two battery cells. As a result, the protective element advantageously forms intercellular insulation, in particular for the purpose of avoiding or at least slowing down propagation of thermal runaway to adjoining cells. By virtue of this arrangement of the protective element and/or when a suitable choice is made of the material of the at least one insulating layer, requirements for compressibility and/or alternating mechanical stress and/or heat distribution between and/or in the two cells of the device can, for example, additionally be addressed.

Alternatively, the device can also be a component in an internal combustion engine.

Further preferred features and/or advantages of the invention form the subject of the following description and of the drawings of exemplary embodiments.

### BRIEF DESCRIPTION OF THE DRAWINGS

FIG. 1 shows a schematic illustration of a cross section of a first embodiment of the protective element;

FIG. 2 shows a schematic illustration of a cross section of a second embodiment of the protective element;

FIG. 3 shows a schematic illustration of a cross section of a third embodiment of the protective element;

FIG. 4 shows a schematic illustration of a cross section of a fourth embodiment of the protective element;

FIG. 5 shows a schematic illustration of a cross section of a fifth embodiment of the protective element;

FIG. 6 shows a schematic illustration of a cross section of a sixth embodiment of the protective element;

FIG. 7 shows a schematic illustration of a cross section of a seventh embodiment of the protective element;

FIG. 8 shows a schematic illustration of a cross section of an eighth embodiment of the protective element; and

FIG. 9 shows a schematic illustration of a cross section of a ninth embodiment of the protective element.

Identical or functionally equivalent elements are provided with the same reference signs in all the figures.

### DETAILED DESCRIPTION OF THE DRAWINGS

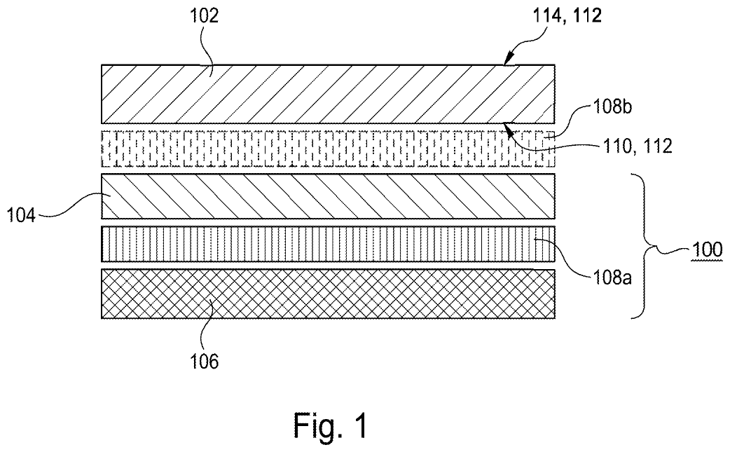

Referring to FIG. 1, a schematic illustration of a cross section of a protective element 100 according to a first embodiment is shown.

The embodiment shown of the protective element 100 at the same time illustrates the simplest embodiment.

The protective element 100 is used for arrangement on or in a device 102. The device 102 is, for the sake of simplicity, illustrated in the Figures only as a hatched rectangle.

The device 102 can preferably be an electrical energy storage device, in particular a housing of such a device. Alternatively, the device 102 is, for example:
a module cover; and/or
a battery cover; and/or
an electrical energy storage device; and/or
a battery cell.

It is moreover conceivable that the device 102 is a component in an internal combustion engine.

The protective element 100 is used in particular to protect the device 102, in particular a wall of the device or neighboring elements which are to be protected.

The protective element 100 can preferably extend completely along the length and/or surface of the device 102 such that the protective element 100 completely surrounds the device 102.

Alternatively, the protective element 100 can extend along the length and/or surface of the device 102 only in some regions such that only a part of the device 102 is covered by the protective element 100.

The protective element 100 comprises a carrier structure 104. In the exemplary embodiment according to FIG. 1, the carrier structure 104 takes the form of a carrier layer. Within the meaning of this application, the term layer can be understood to mean a geometry of the respective component, the longitudinal extent or surface area of which is greater than its vertical extent or its thickness, for example by a factor of at least approximately 5, in particular at least approximately 20.

Alternatively (although this is not shown), the carrier structure 104 can also comprise a plurality of carrier layers.

The carrier structure 104 can moreover include a metal or preferably be formed from a metal.

Particularly preferably, the carrier structure 104 is formed from a solid material, i.e. it is formed from a compact body of a material, for example stainless steel or aluminum.

As a result, the carrier structure 104 advantageously forms a kind of core of the protective element 100 which, because of the material used, exerts a mechanical and/or thermal protective effect.

The carrier structure 104 preferably stabilizes the protective element 100. Moreover, the carrier structure 104 preferably protects one or more insulating layers 106 from mechanical and/or thermal and/or chemical stress.

According to one embodiment, the carrier structure 104 can include wood and/or a plastic or be formed from such a material. This has proved to be advantageous in particular in terms of a reduction in weight of the carrier structure 104.

The carrier structure 104 preferably extends over the whole surface, i.e. over the whole width and/or length, of the device 102. This is illustrated in FIG. 1.

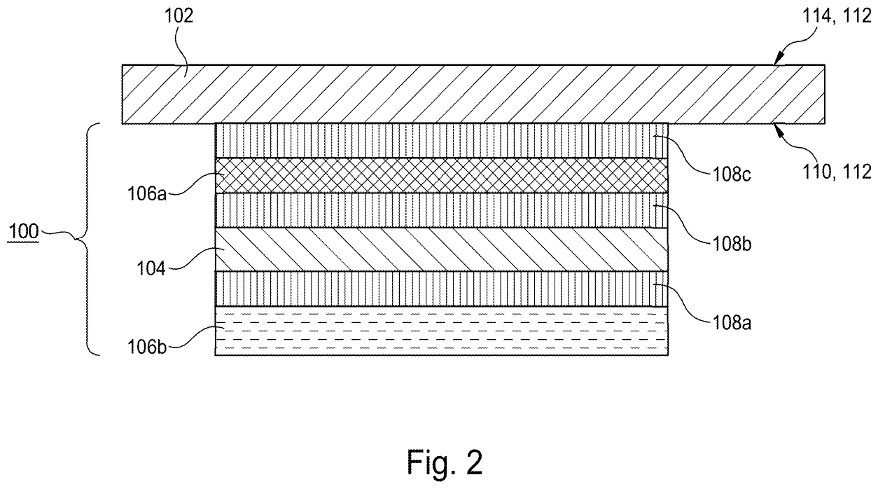

Alternatively, the carrier structure 104 can preferably extend over or along the device 102 only in some regions such that only a part of the device 102 is covered by the carrier structure 104. This is illustrated graphically below in FIGS. 2 to 9.

The protective element 100 furthermore has an insulating layer 106. The insulating layer 106 serves to protect, in particular to insulate, the device 102.

Accordingly, the insulating layer 106 takes the form in particular of electrical and/or thermal and/or electromagnetic insulation of the device 102 or forms such insulation.

The insulating layer 106 can, for example, include a thermally insulating material or be formed therefrom. Nonrestrictive examples of such thermally insulating materials are silica fibers and/or thermal insulating paper and/or glass fabric and/or ceramic fiber mats.

Alternatively or additionally, the insulating layer 106 can preferably include an electrically insulating material or be formed from such a material. Nonrestrictive examples of electrically insulating materials are plastics and/or ceramics and/or plastic films.

By virtue of the use of a ceramic as the material of the insulating layer 106, thermal insulation and/or mechanical robust reinforcement is, for example, also achieved in addition to the electrical insulation. The mechanical robust reinforcement has proven to be advantageous in particular in the case of particle impacts, for example in the event of thermal runaway.

Furthermore, alternatively or additionally, the insulating layer 106 can include an electromagnetically insulating material. A nonrestrictive example of electromagnetically insulating materials are ferromagnetic materials, for example mu-metal.

The insulating layer 106 preferably has a thickness in the range from 0.01 mm to 1 mm, in particular in the range from 0.05 mm to 0.8 mm, and specifically in the range from 0.2 mm to 0.6 mm.

For example, the thickness of the insulating layer 106 can vary depending on the material used and depending on a required insulation property.

The protective element 100 comprises a connecting layer 108a for connecting the carrier structure 104 to the insulating layer 106.

The connecting layer 108a can be, for example, an adhesive layer which connects the carrier structure 104 and the insulating layer 106 to each other in the manner of an adhesive.

The connecting layer 108a can preferably include a binder or be formed from a binder. In particular, the binder is a ceramic-based binder.

Such a ceramic-based binder preferably additionally provides electrical and/or thermal insulation and thus preferably increases the thermal and/or electrical overall insulating effect of the protective element 100.

According to a further embodiment, the binder is preferably a glass-based binder. Such binders have advantageously also proven to be suitable in terms of their electrically and/or thermally insulating effect.

In an alternative exemplary embodiment, it can be advantageous if the binder is an epoxy-based binder. Epoxy-based binders have the advantage that they are resistant to alkalis and/or acids and/or solvents.

According to a further embodiment, the binder is preferably a water-based binder.

By virtue of the possibility of varying the material of the connecting layer 108a, it is thus made possible, as already mentioned, to adapt simply to protection requirements which have been set, this advantageously increasing the overall protective effect of the protective element 100 and making it adaptable.

The protective element 100 can moreover also, as shown in FIG. 1, be arranged by a connecting layer 108b on an outer side 110 of a wall 112 of the device 102. This optional connecting layer 108b is illustrated in FIG. 1 only in dashed lines.

The carrier structure 104 is thus connected on one side to the device 102 by means of a connecting layer 108b and on the other side to the insulating layer 106 by means of a connecting layer 108a.

The carrier structure 104, the connecting layer 108a which is arranged between the carrier structure 104 and the insulating layer 106, and the insulating layer 106 here form the protective element 100.

Alternatively, the protective element 100 can also be arranged on an inner side 114 of the wall 112 of the device 102.

Moreover, in an embodiment which is not shown it is conceivable that a protective element 100 is arranged both on an inner side 114 of the wall 112 and on an outer side 110 of the wall 112.

Furthermore, the protective element 100 can alternatively also be attached, for example screwed, to the device 102 in a different manner. In order to illustrate this embodiment, the connecting layer 108b which is arranged between the device 102 and the carrier structure 104 is illustrated in FIG. 1 only in dashed lines.

Viewed in the direction of the device 102 within the plane of the drawing, the protective element 100 thus has the following structure: insulating layer 106, connecting layer 108a, carrier structure 104, (optional) connecting layer 108b.

Moreover, all the layers 104, 106, 108a, b extend along the whole length and/or surface of the protective element 100. Alternatively, it is however conceivable that one or more of the said layers 104, 106, 108a, b extend along the length and/or surface of the protective element 100 only in some regions.

Illustrated in FIG. 2 is a second embodiment of the protective element 100 according to the invention.

As can be seen in the cross section shown, the protective element 100 also has a carrier structure 104.

Furthermore, the protective element 100 according to FIG. 2 has, in contrast to the protective element 100 according to FIG. 1, two insulating layers 106a, b.

The two insulating layers 106a, b preferably differ in terms of their insulating properties. In particular, but not nonrestrictively, the two insulating layers 106a, b can differ in terms of their thermal and/or electrical and/or electromagnetic insulating property. A difference in terms of their mechanical protectiveness, robustness and/or resistance is also conceivable.

As a nonrestrictive example, one of the two insulating layers 106a, b can take the form of an electrical insulating layer for electrical insulation, whilst the other insulating layer 106a, b can take the form of a thermal insulating layer for thermal insulation.

A protective element 100 which takes this form thus preferably provides electrical and thermal protection or electrical and thermal insulation.

However, other combinations of different insulation materials and properties are moreover also conceivable such that the protective element 100 can be adapted individually.

The insulating layers 106a, b are connected to the carrier structure 104 via connecting layers 108a, b. As can be seen in FIG. 2, the insulating layers 106a, b are arranged on both sides of the carrier structure 104. In each case one connecting layer 108a, b connects one of the insulating layers 106a, b to in each case one side of the carrier structure 104.

The protective element 100 is moreover arranged on the device 102 by a connecting layer 108c. In the exemplary embodiment according to FIG. 2, this connecting layer 108c is also part of the protective element 100.

Viewed in the direction of the device 102 within the plane of the drawing, the protective element 100 thus has the following structure: insulating layer 106b, connecting layer 108a, carrier structure 104, connecting layer 108b, insulating layer 106a, connecting layer 108c.

Moreover, all the layers 104, 106a, b, 108a, b, c extend along the whole length and/or surface of the protective element 100. Alternatively, it is however conceivable that one or more of the said layers 104, 106a, b, 108a, b, c extend along the length and/or surface of the protective element 100 only in some regions.

As can be seen in FIG. 2, the protective element 100 does not extend over the whole surface of the device 102. Instead, the protective element 100 is arranged on the device 102 only in some regions.

Moreover, the layers 104, 106a, b, 108a, b, c can have different thicknesses and/or structured surfaces.

Apart from that, the embodiment of a protective element 100 illustrated in FIG. 2 corresponds in terms of its function and/or mode of operation and/or ability to have a modular structure to the embodiment illustrated in FIG. 1 such that in these respects reference is made to the above description thereof.

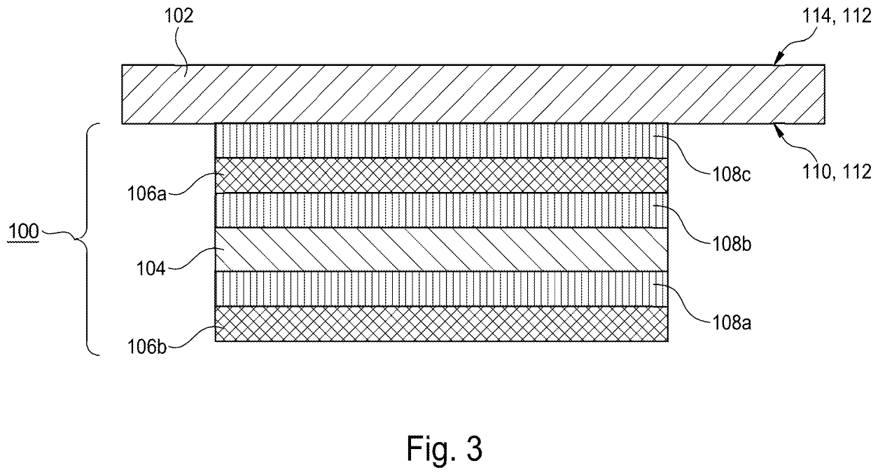

With reference to FIG. 3, a third embodiment of the protective element 100 according to the invention is shown in cross section.

The protective element 100 also has a carrier structure 104.

The protective element 100 furthermore has two insulating layers 106a, b. The insulating layers 106a, b are preferably arranged on both sides of the carrier structure 104, namely an insulating layer 106a on one side and an insulating layer 106b on the other side of the carrier structure 104.

The two insulating layers 106a, b are in each case connected to the carrier structure 104 via a connecting layer 108a, b.

In the exemplary embodiment according to FIG. 3, the two insulating layers 106a, b include the same insulating material. This is illustrated graphically in FIG. 3 by the same hatching.

For example, but nonrestrictively, the two insulating layers 106a, b include an electrically insulating material. As a result, the electrical insulating performance of the protective element 100 is preferably increased.

In an alternative configuration, the two insulating layers 106a, b include a thermally insulating material.

According to a further embodiment, the two insulating layers 106a, b include an electromagnetically insulating material.

Viewed in the direction of the device 102 within the plane of the drawing, the protective element 100 thus has the following structure: insulating layer 106b, connecting layer 108a, carrier structure 104, connecting layer 108b, insulating layer 106a, connecting layer 108c.

Moreover, all the layers 104, 106a, b, 108a, b, c extend along the whole length and/or surface of the protective element 100. Alternatively, it is however conceivable that one or more of the said layers 104, 106a, b, 108a, b, c extend along the length and/or surface of the protective element 100 only in some regions.

Furthermore, the layers 104, 106a, b, 108a, b, c have different thicknesses and/or structured surfaces.

Apart from that, the embodiment of a protective element 100 illustrated in FIG. 3 corresponds in terms of its function and/or mode of operation and/or ability to have a modular structure to the embodiments illustrated in FIGS. 1 and 2 such that in these respects reference is made to the above description thereof.

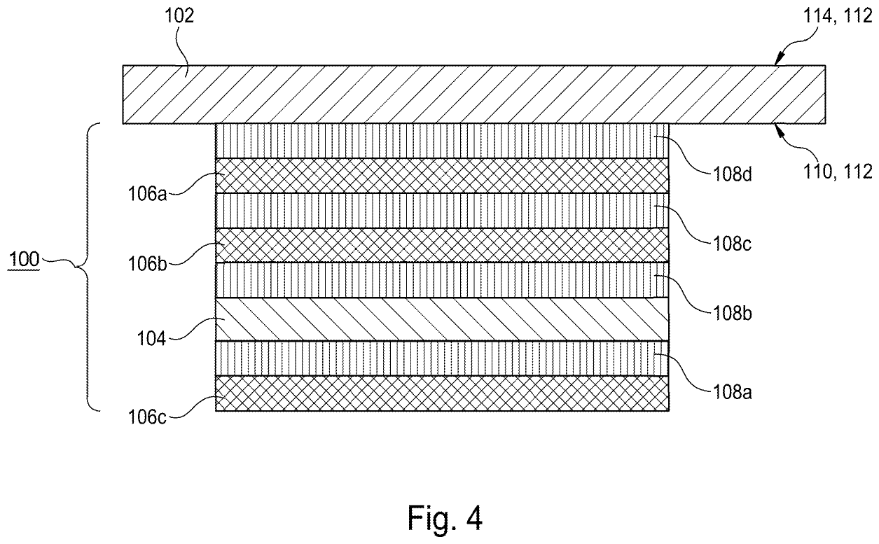

Illustrated in FIG. 4 is a fourth embodiment of the protective element 100 according to the invention in cross section.

As is the case with the already described protective elements 100, the protective element 100 according to the fourth embodiment also has a carrier structure 104. Likewise, the carrier structure 104 according to FIG. 4 preferably takes the form of a carrier layer.

However, the protective element 100 according to the fourth embodiment comprises three insulating layers 106a, b, c.

An insulating layer 106c is arranged on one side of the carrier structure 104 by a connecting layer 108a. Also, an insulating layer 106b is arranged on the other side of the carrier structure 104 by means of a further connecting layer 108b. The carrier structure 104 according to FIG. 4 thus has an insulating layer 106b, c on both sides.

Viewed in the plane of the drawing, a further insulating layer 106a is arranged on the insulating layer 106b facing the device 102 via a connecting layer 108c.

This further insulating layer 106a is moreover preferably arranged, by means of a connecting layer 108d, on the device 102 and in particular on the outer side 110 of the wall 112 of the device 102.

Alternatively, the protective element 100 according to FIG. 4 can also be arranged on the inner side 114 of the wall 112 or on both sides of the wall 112.

In total, the protective element 100 according to the fourth embodiment therefore has a carrier structure 104, three insulating layers 106a, b, c, and four connecting layers 108a, b, c, d.

Viewed in the direction of the device 102 within the plane of the drawing, the protective element 100 thus has the following structure: insulating layer 106c, connecting layer 108a, carrier structure 104, connecting layer 108b, insulating layer 106b, connecting layer 108c, insulating layer 106a, connecting layer 108d.

Moreover, all the layers 104, 106a, b, c, 108a, b, c, d extend along the whole length and/or surface of the protective element 100. Alternatively, it is however conceivable that one or more of the said layers 104, 106a, b, c, 108a, b, c, d extend along the length and/or surface of the protective element 100 only in some regions.

Moreover, the layers 104, 106a, b, c, 108a, b, c, d can have different thicknesses and/or structured surfaces.

Apart from that, the embodiment of a protective element 100 illustrated in FIG. 4 corresponds in terms of its function and/or mode of operation and/or ability to have a modular structure to the embodiments illustrated in FIGS. 1 to 3 such that in these respects reference is made to the above description thereof.

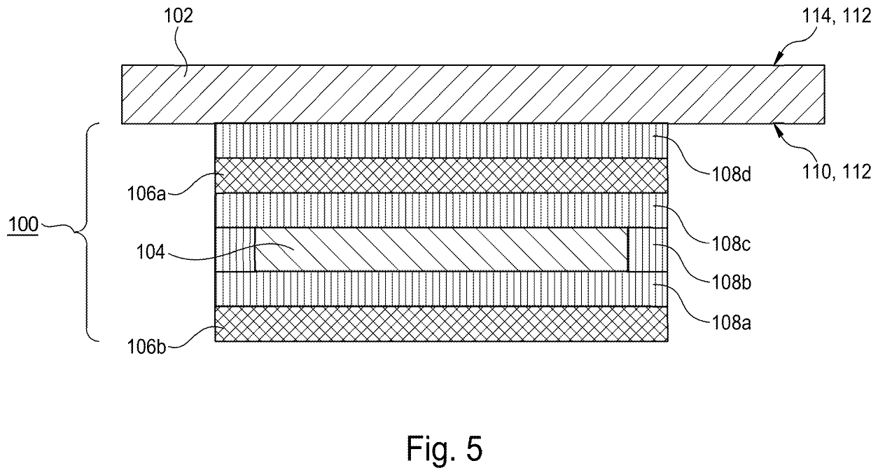

The fifth embodiment of a protective element 100 according to the invention shown with reference to FIG. 5 is also arranged on the device 102.

As is the case with the protective elements 100 already described above, the protective element 100 according to FIG. 5 also has a carrier structure 104.

The carrier structure 104 does not, however, extend over the whole length of the protective element 100.

Instead, the carrier structure 104, in contrast to the exemplary embodiments already explained, is also surrounded at its end faces by the connecting layer 108b.

In this exemplary embodiment, the carrier structure 104 is thus completely surrounded by the connecting layer 108a, b, c.

The protective element 100 is attached to the device 102 via a further connecting layer 108d with the insulating layer 106a, in particular to the outer side 110 of the wall 112 of the device 102.

Such a configuration with a completely surrounded carrier structure 104 can prove to be advantageous in particular in the case of the protective element 100 being arranged on or in the device 102 only in some regions.

Because the end faces of the carrier structure 104 are surrounded by the connecting layer 108b, insulation at the end faces of the carrier structure 104 is consequently preferably also formed. This is in particular the case when the connecting layer 108b preferably includes a binder with insulating properties of the already described type.

Viewed in the direction of the device 102 within the plane of the drawing, the protective element 100 thus has the following structure: insulating layer 106b, connecting layer 108a, carrier structure 104 surrounded by a connecting layer 108b, connecting layer 108c, insulating layer 106a, connecting layer 108d.

Moreover, the layers 104, 106a, b, , 108a, b, c, d can have different thicknesses and/or structured surfaces.

Apart from that, the embodiment of a protective element 100 illustrated in FIG. 5 corresponds in terms of its function and/or mode of operation and/or ability to have a modular structure to the embodiments illustrated in FIGS. 1 and 4 such that in these respects reference is made to the above description thereof.

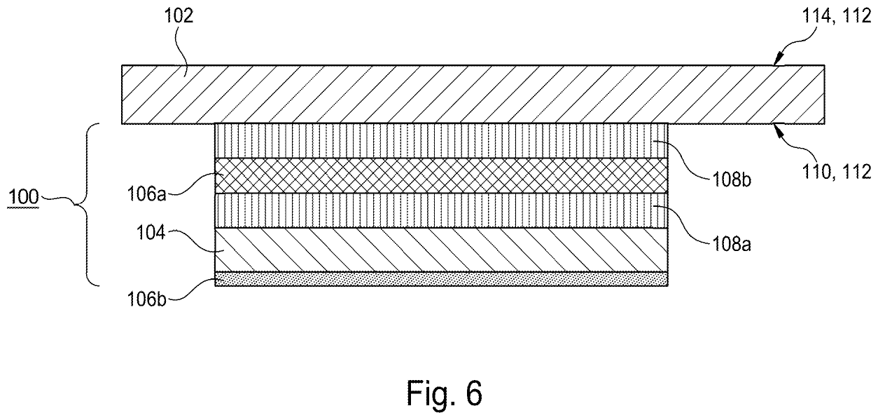

With Reference to FIG. 6, a cross section of a sixth embodiment of the protective element 100 is illustrated.

In terms of the structure, the protective element 100 according to FIG. 6 also has a carrier structure 104. The carrier structure 104 preferably takes the form of a carrier layer.

In contrast to the protective elements 100 already described, the protective element 100 shown in FIG. 6 has an insulating layer 106b in the form of a coating. This insulating layer 106b is arranged on, in particular applied to, the carrier structure 104.

The insulating layer 106b in the form of a coating is preferably thinner than an insulating layer 106 in the form of an individual insulating layer.

The protective element 100 can preferably be configured as thinner overall, advantageously without having to sacrifice or reduce insulating properties.

In the exemplary embodiment according to FIG. 6, the insulating layer 106b in the form of a coating is arranged on, in particular applied to, the carrier structure 104 directly, i.e. preferably with no connecting layer 108.

Furthermore, the protective element 100 also has an insulating layer 106a which takes the form of an individual insulating layer. A connecting layer 108a, by means of which the insulating layer 106a is connected to the carrier structure 104, is arranged between this insulating layer 106a and the carrier structure 104.

The insulating layer 106b in the form of a coating and the insulating layer 106a in the form of an individual insulating layer preferably differ in terms of their insulating properties. In particular, the two insulating layers 106a, b differ in terms of their thermal and/or electrical and/or electromagnetic insulating properties.

The protective element 100 according to FIG. 6 is, in a similar fashion to the already explained exemplary embodiments, arranged on the device 102 with the insulating layer 106a in the form of an individual insulating layer. For this purpose, for the connection, a connecting layer 108b is arranged between the insulating layer 106a and the device 102.

Viewed in the direction of the device 102 within the plane of the drawing, the protective element 100 thus has the following structure: insulating layer 106b in the form of a coating, carrier structure 104, connecting layer 108a, insulating layer 106a, connecting layer 108b.

Moreover, all the layers 104, 106a, b, 108a, b extend along the whole length and/or surface of the protective element 100. Alternatively, it is however conceivable that one or more of the said layers 104, 106a, b, 108a, b extend along the length and/or surface of the protective element 100 only in some regions.

Moreover, the layers 104, 106a, b, 108a, b can have different thicknesses and/or structured surfaces.

Apart from that, the embodiment of a protective element 100 illustrated in FIG. 6 corresponds in terms of its function and/or mode of operation and/or ability to have a modular structure to the embodiments illustrated in FIGS. 1 and 5 such that in these respects reference is made to the above description thereof.

In the seventh exemplary embodiment of the protective element 100 according to the invention, the protective element 100 is also connected to the device 102 via a connecting layer 108b.

In the exemplary embodiment shown, the protective element 100 is arranged on an outer side 110 of the wall 112 of the device 102. Alternatively or additionally, the protective element 100 can however also be arranged on an inner side 114 of the wall 112 of the device 102.

According to this exemplary embodiment, the protective element 100 has a carrier structure 104.

The carrier structure 104 is connected to an insulating layer 106a on one side via a connecting layer 108a. This insulating layer 106a preferably takes the form of an individual insulating layer.

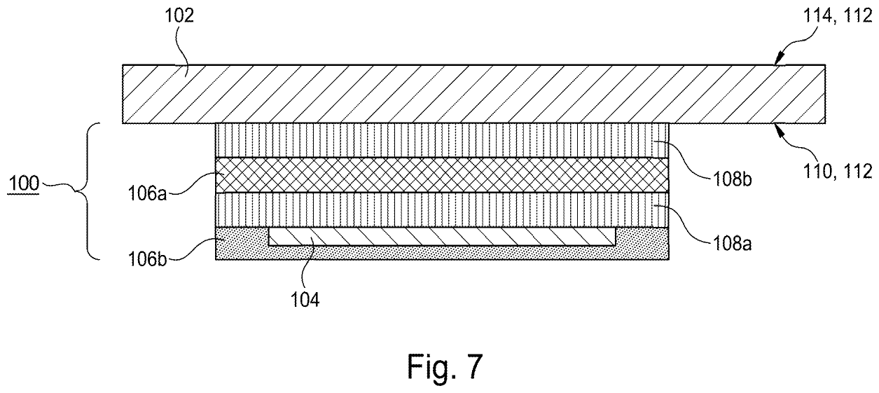

As can be seen in FIG. 7, the carrier structure 104 also extends in this exemplary embodiment along the protective element 100 only in some regions. The carrier structure 104 thus does not extend over the whole length of the protective element 100.

The region of the carrier structure 104 which is not connected to the connecting layer 108a is, in the exemplary embodiment according to FIG. 7, completely surrounded by an insulating layer 106b.

In particular, this insulating layer 106b takes the form of a coating.

The insulating layer 106b therefore preferably also surrounds the end faces of the carrier structure 104. The carrier structure 104 is thus preferably completely enclosed by the insulating layer 106b and the connecting layer 108a.

The carrier structure 104 can advantageously be protected from various influences such as, for example, chemical and/or physical influences by the insulating layer 106b in the form of a coating.

Alternatively or additionally, the insulating layer 106b also provides an insulating and thus protective effect such that the device 102 is preferably also insulated and consequently protected.

Particularly preferably, in this exemplary embodiment the two insulating layers 106a, b also differ in terms of their insulating properties. In particular, the two insulating layers 106a, b differ in terms of their thermal and/or electrical and/or electromagnetic insulating properties.

Viewed in the direction of the device 102 within the plane of the drawing, the protective element 100 thus has the following structure: insulating layer 106b, carrier structure 104 surrounded by the insulating layer 106b, connecting layer 108a, insulating layer 106a, connecting layer 108b.

Moreover, the Layers 104, 106a, b, 108a, b Can Have Different Thicknesses And/or structured surfaces.

Apart from that, the embodiment of a protective element 100 illustrated in FIG. 7 corresponds in terms of its function and/or mode of operation and/or ability to have a modular structure to the embodiments illustrated in FIGS. 1 and 6 such that in these respects reference is made to the above description thereof.

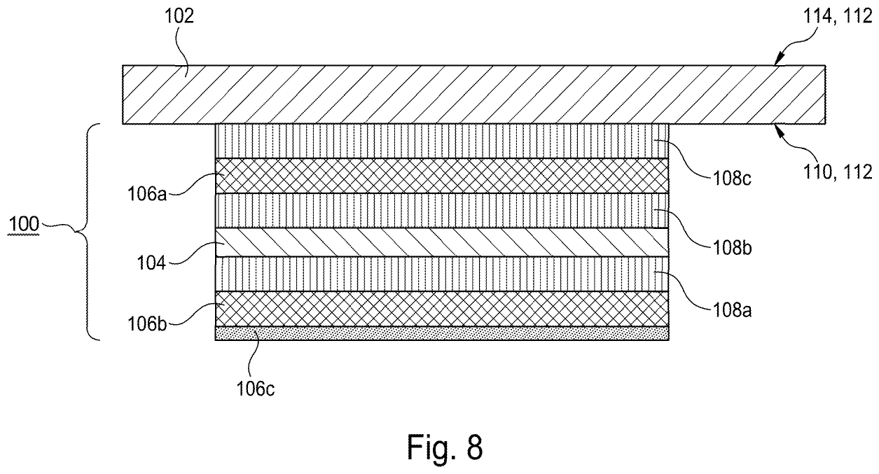

A further embodiment of the protective element 100 is shown in cross section in FIG. 8.

In this exemplary embodiment too, the protective element 100 has a carrier structure 104. The carrier structure 104 preferably takes the form of a carrier layer.

A connecting layer 108a, b is arranged on both sides of the carrier structure 104. In each case one insulating layer 106a, b is connected to the carrier structure 104 by these connecting layers 108a, b.

The carrier structure 104 thus has a connecting layer 108a, b on each side and an insulating layer 106a, b adjoining the connecting layer 108a, b and connected thereto.

An additional insulating layer 106c is arranged on, in particular applied to, one of the insulating layers 106b. The additional insulating layer 106c for this purpose preferably takes the form of a coating.

Particularly preferably, the additional insulating layer 106c is attached or applied to the insulating layer 106b directly, i.e. preferably without a connecting layer 108 situated in between.

The insulating effect of the insulating layer 106b can be further increased by the additional insulating layer 106c. Alternatively or additionally, a further insulating property can preferably also be covered by the additional insulating layer 106c.

It is thus, for example, conceivable if the insulating layer 106b is an electrical insulating layer for electrical insulation and the additional insulating layer 106c is a thermal insulating layer for thermal insulation. By virtue of such an insulating composite, both electrical and thermal insulation of the device 102 can advantageously be obtained.

Additionally, in this exemplary embodiment the insulating layer 106a can, for example, take the form of an insulating layer which is electromagnetically insulating such that the protective element 100 in this exemplary embodiment electrically, thermally, and electromagnetically insulates the device 102.

The device 102 can thus be protected by the protective element 100 from electrical, thermal, and electromagnetic influences.

In the exemplary embodiment shown, the protective element 100 is arranged on an outer side 110 of the wall 112 of the device 102. Alternatively or additionally, the protective element 100 can however also be arranged on an inner side 114 of the wall 112 of the device 102.

Viewed in the direction of the device 102 within the plane of the drawing, the protective element 100 thus has the following structure: insulating layer 106c in the form of a coating, insulating layer 106b, connecting layer 108a, carrier structure 104, connecting layer 108b, insulating layer 106a, connecting layer 108c.

Moreover, all the layers 104, 106a, b, c, 108a, b, c extend along the whole length and/or surface of the protective element 100. Alternatively, it is however conceivable that one or more of the said layers 104, 106a, b, c, 108a, b, c extend along the length and/or surface of the protective element 100 only in some regions.

Furthermore, the layers 104, 106a, b, c, 108a, b, c can have different thicknesses and/or structured surfaces.

Apart from that, the embodiment of a protective element 100 illustrated in FIG. 8 corresponds in terms of its function and/or mode of operation and/or ability to have a modular structure to the embodiments illustrated in FIGS. 1 to 7 such that in these respects reference is made to the above description thereof.

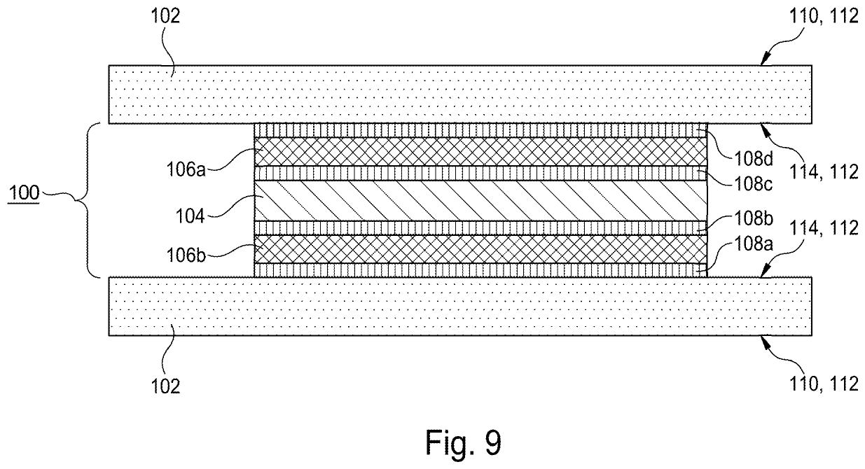

FIG. 9 shows an alternative configuration of the protective element 100. In this ninth embodiment, the protective element 100 is arranged between two devices 102. The devices 102 can be, for example, battery cells.

The protective element 100 is here preferably arranged between the inner sides 114 of the wall 112 of the devices 102.

By virtue of such an arrangement of the protective element 100, the two devices 102, in particular the two battery cells, can be insulated with respect to each other and consequently protected.

In the exemplary embodiment according to FIG. 9, the protective element 100 has a carrier structure 104.

The carrier structure 104 preferably takes the form of a carrier layer.

A connecting layer 108a, b is arranged on both sides of the carrier structure 104. In each case one insulating layer 106a, b adjoins the two connecting layers 108a, b on both sides of the carrier structure 104.

The two insulating layers 106a, b are connected, in particular by adhesive bonding, to the carrier structure 104 by the connecting layers 108.

For connection to the devices 102, connecting layers 108a, d are likewise arranged on that side of the insulating layers 106a, b which faces away from the carrier structure 104.

Each of these connecting layers 108a, b connects, in particular by adhesive bonding, the protective element 100 to in each case an inner side 114 of the devices 102.

Viewed from bottom to top within the plane of the drawing, the protective element 100 according to FIG. 9 thus has the following structure: connecting layer 108a, insulating layer 106b, connecting layer 108b, carrier structure 104, connecting layer 108c, insulating layer 106a, connecting layer 108d.

The two insulating layers 106a, b preferably differ in terms of their insulating properties, in particular in terms of their thermal and/or electrical and/or electromagnetic insulating properties.

The insulating layer 106a takes the form, for example, of a thermal insulating layer. The other insulating layer 106b here takes the form, for example, of an electrical insulating layer.

Both electrical and thermal protection of the devices 102 can advantageously be achieved by such a structure of the protective element 100.

Alternatively, according to one embodiment the two insulating layers 106a, b can have the same insulating property. The protective element 100 here preferably has a symmetrical structure in terms of the layers 106a, b, 108a, b, c, d arranged on both sides of the carrier structure 104.

Such protection can be advantageous in particular in the case of use of the protective element 100 between two battery cells in order to prevent the two battery cells influencing each other thermally and/or electrically. For example, in the case of thermal runaway of one of the battery cells, the associated effects on the other battery cell can be at least reduced.

Also, in the exemplary embodiment according to FIG. 9, all the layers 104, 106a, b, 108a, b, c, d extend along the whole length and/or surface of the protective element 100. Alternatively, it is however conceivable that one or more of the said layers 104, 106a, b, c, 108a, b, c, d extend along the length and/or surface of the protective element 100 only in some regions.

Moreover, the layers 104, 106a, b, 108a, b, c, d can have different thicknesses and/or structured surfaces.

Apart from that, the embodiment of a protective element 100 illustrated in FIG. 9 corresponds in terms of its function and/or mode of operation and/or ability to have a modular structure to the embodiments illustrated in FIGS. 1 and 8 such that in these respects reference is made to the above description thereof.

The configuration of the insulating properties, mentioned by way of example above, of the insulating layers 106, 106a, b, c of all of the exemplary embodiments is, however, not limited to the insulating properties mentioned and not provided only in the combinations mentioned. Instead, the insulating layers 106, 106a, b, c with different insulating properties and/or thicknesses can preferably be combined with one another as desired in order to make it possible to adapt the protective element 100 optimally and simply to the respective requirements. It is, for example, moreover conceivable that one or more insulating layers 106, 106a, b, c are designed as thermally insulating and at the same time are mechanically stable and consequently can also withstand mechanically acting forces.

In further embodiments (not illustrated) of protective elements 100, individual or multiple features and/or advantages of the abovementioned embodiments can be combined with one another as desired. For example, in the embodiment illustrated in FIG. 1, an insulating layer 106 and/or the carrier structure 104 can also be provided in some regions or completely with an insulating layer 106b, in the form of a coating, according to the embodiment illustrated in FIG. 7.

### LIST OF REFERENCE SIGNS

100 protective element
102 device
104 carrier structure
106 insulating layer
106a insulating layer
106b insulating layer
106c insulating layer
108a connecting layer
108b connecting layer
108c connecting layer
108d connecting layer
110 outer side of the wall
112 wall of the device
114 inner side of the wall

1. A protective element for arrangement on or in a device or on or in an electrical energy storage device, wherein the protective element comprising:
a carrier structure; and
at least one insulating layer; and
at least one connecting layer for connecting the carrier structure to the at least one insulating layer.

2. The protective element according to claim 1, wherein the carrier structure comprises one or more carrier layers or one or more metal layers.

3. The protective element according to claim 1, wherein the protective element comprises a plurality of insulating layers which are arranged on both sides of the carrier structure.

4. The protective element according to claim 3, wherein a plurality of the insulating layers differ in terms of mechanical properties of said plurality of the insulating layers and/or in terms of insulating properties of said plurality of the insulating layers, or in terms of thermal and/or electrical and/or electromagnetic insulating properties of said plurality of the insulating layers.

5. The protective element according to claim 3, wherein precisely one connecting layer is arranged between each of a plurality of the insulating layers.

6. The protective element according to claim 1, wherein at least one insulating layer has a thickness in the range from 0.01 mm to 1 mm, or in the range from 0.05 mm to 0.8 mm, or in the range from 0.2 mm to 0.6 mm.

7. The protective element according to claim 1, wherein at least one insulating layer has different thicknesses in some regions and/or a structured surface.

8. The protective element according to claim 1, wherein at least one insulating layer comprises a coating or an individual insulating layer, or is a coating or an individual insulating layer.

9. The protective element according to claim 1, wherein the protective element is arranged on or in the device at least in some regions, or on an outer side or an inner side of a wall of the device.

10. The protective element according to claim 1, wherein at least one insulating layer surrounds the carrier structure in some regions or completely.

11. The protective element according to claim 1, wherein the carrier structure includes a metal or is formed therefrom, or stainless steel and/or aluminum.

12. The protective element according to claim 1, wherein at least one insulating layer includes a thermally insulating material or is formed therefrom, or silica fibers and/or thermal insulating paper and/or glass fabric and/or ceramic fiber mats.

13. The protective element according to claim 1, wherein at least one insulating layer includes an electrically insulating material or is formed therefrom, or a plastic and/or a ceramic and/or a plastic film.

14. The protective element according to claim 8, wherein the coating is a ceramic-based coating and/or a water-based coating and/or a glass-based coating and/or an epoxy-based coating and/or a powder coating.

15. The protective element according to claim 1, wherein at least one connecting layer includes a binder or is formed therefrom, or a ceramic-based binder and/or a water-based binder and/or a glass-based binder and/or an epoxy-based binder.

16. The protective element according to claim 1, wherein at least one connecting layer includes an adhesive or is formed therefrom, or an acrylate-based adhesive.

17. A device with said protective element according to claim 1.

18. The device according to claim 17, wherein the device takes the form of a housing, a module cover, a battery cell, a component in an internal combustion engine, or an electrical energy storage device.
